(19) United States
(12) Patent Application Publication
(10) Pub. No.: US 2009/0150420 A1
(43) Pub. Date: Jun. 11, 2009

(54) GENERATING DEBUG INFORMATION

(75) Inventor: Daniel TOWNER, Bath (GB)

Correspondence Address: POTOMAC PATENT GROUP PLLC, P. O. BOX 270, FREDERICKSBURG, VA, 22404, US

(73) Assignee: Picochip Designs Limited, Bath (GB)

(21) Appl. No.: 12/265,152

(22) Filed: Nov. 5, 2008

(30) Foreign Application Priority Data
Nov. 5, 2007 (GB) 0721715.1

(51) Int. Cl. G06F 7/00; G06F 17/00

(52) U.S. Cl. 707/101; 707/102; 707/E17.005; 707/E17.006

(57) ABSTRACT

There is provided a method of generating information for a software system for use in a debug information database, the software system being defined in a low-level program code, the method comprising constructing a representation of the software system from the low-level program code; examining the representation to identify predetermined patterns; and generating a database of debug information for the software system from the results of the step of examining.

### TECHNICAL FIELD OF THE INVENTION

The invention relates to generating debug information for software, and in particular relates to a method for generating high-level symbolic debug information from low-level object or assembly code.

### BACKGROUND TO THE INVENTION

A debugger is a tool for monitoring, testing and examining a software system represented using object code. Particular types of debuggers, such as source-level debuggers or symbolic debuggers, allow the user to view the software system in relation to the source code from which it was originally compiled.

A debugger has various functions and abilities, including mapping a current execution position in the object code back to the original source line from which that execution position's code was compiled; relating the contents of memory, registers, or other data storage of the software system to variables, constants or other symbolic data storage in the original source program; allowing high-level source constructs, such as functions, procedures and modules, to be viewed; and allowing relational information such as function call hierarchies on the executing software system to be constructed.

The debugger is able to relate the properties of the executing software system back to the original source language used to implement the system through a debug information database. The compiler normally generates this database when it turns the source code into the object code, and the database is typically stored in a standardised format, for example DWARF (Debug With Arbitrary Record Format), COFF (Common Object File Format) or STABS. The database must be retained, along with the object code, if the debugger is to be able to generate high-level symbolic representations of the executing system being debugged.

Debug information can be divided into two broad categories: source information, and high-level construct information. Source information includes file names, function names, variable names, line numbers, and so on. Construct information includes the boundaries of functions, the types and locations of variables, loop blocks, and so on.

Conventionally, if the debug information database is lost or unavailable, the debugger cannot display any symbolic information for an executing system. Thus, the debugger cannot display the source information or construct information.

Therefore, there is a need for a method that allows high-level symbolic debug information, and specifically construct information, to be generated from low-level object or assembly code.

### SUMMARY OF THE INVENTION

According to a first aspect of the invention, there is provided a method of generating information for a software system for use in a debug information database, the software system being defined in a low-level program code, the method comprising constructing a representation of the software system from the low-level program code; examining the representation to identify predetermined patterns; and generating a database of debug information for the software system from the results of the step of examining.

Another aspect of the invention provides a computer program comprising code that performs the method described above when executed in a computer.

A further aspect of the invention provides a computer program product comprising a computer program as described above embodied therein.

### BRIEF DESCRIPTION OF THE DRAWINGS

The invention will now be described, by way of example only, with reference to the following drawings, in which:

FIG. 1 is a flow chart illustrating a method in accordance with the invention;

FIG. 2 is a flow chart illustrating a further method in accordance with the invention; and

FIG. 3 is an exemplary control-flow graph in accordance with the invention.

### DETAILED DESCRIPTION OF THE PREFERRED EMBODIMENTS

Although the invention will now be described with reference to generating a database of debug information from a software system defined in terms of object (machine) or assembly code, it will be appreciated that the invention is applicable to the generation of a database from a software system that is defined in terms of any other type of low-level language that does not support direct representation of concepts such as functions, but which are nonetheless used by programmers.

In many environments, assembly language is only used as a last resort when high-level symbolic languages are not suitable (for example they are too slow or require too much code). It is usual to accept that programming using an assembly language will be subject to restrictions, and one of these restrictions is that symbolic debug information relating to functions, loops, variables, and so on, is lost. Thus, the invention provides a way of recreating the symbolic information from the assembly language.

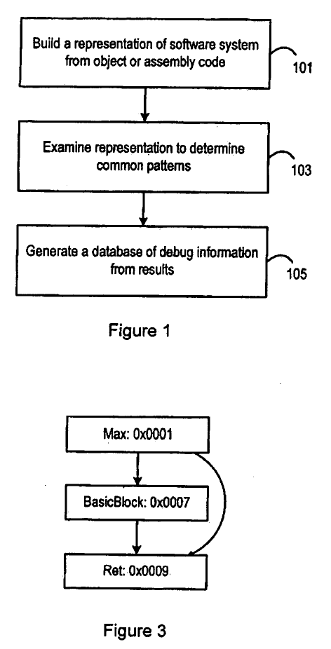

Referring now to FIG. 1, a method of generating a database of debug information from a software system that is defined in terms of object or assembly code is presented. In step 101, a representation of the software system is built from the object or assembly code. As described below, this representation can be built using a control-flow graph, although it is possible to use any suitable technique to form this representation.

In step 103, the representation is examined to identify or determine common patterns therein that may be indicative of program structures such as functions, function parameters, global variables, loops and type structures.

In step 105, a database of debug information is generated from the information determined in step 103. This database can then be used by a debugger to provide a user with a representation of the execution of the software system during debugging.

Thus, the method according to the invention allows high-level symbolic debug information to be generated from low-level object or assembly code, even when a debug database that is usually generated by a compiler is lost or unavailable.

Furthermore, the method according to the invention can be used to augment assembly language code with high-level constructs, such as functions or loops, even when the original language syntax does not support the notion of such constructs.

The method according to the invention is independent of the compiler and the language used to generate the program code from the original source code. It is not necessary to examine the original compilation source-to-binary transformations in order to relate program binary features such as functions and loops back to their original source code. Furthermore, the method will also work on code which has been optimised.

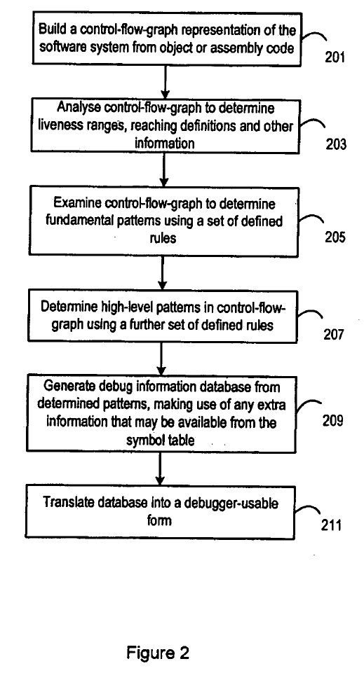

A more detailed implementation of the invention will now be described with reference to FIG. 2. In step 201 of FIG. 2, a representation of the software system is built from the object or assembly code. In this implementation, the representation is a control-flow graph (CFG) of the object or assembly code. The control-flow graph is a representation of the structure of a program, including any paths that might be followed during its execution.

In step 203, the control-flow graph is analysed using various techniques. The output of this step is an intermediate data structure. The techniques can include liveness analysis (which determines how long particular variables are useful in a program and outputs a list of all instructions in the program and the registers that are live for each instruction), which uses reaching-definitions analysis (which determines the part of the program that defines the value of a variable that is used in a later part of the program) or exposed uses analysis. Of course, it will be appreciated that any other suitable type of analysis can be used.

In step 205, the control-flow graph is examined using a first set of defined rules to determine where fundamental patterns exist in the software system. The defined rules can comprise queries that return a true or false result when run on the data structure constructed in step 203. A pattern (for example a function) can be identified if the set of rules for that pattern all return a “true” value. The fundamental patterns include functions, procedures or subroutines, and can be identified, for example, by finding a component of the control-flow graph with one entry node, whose link register is live-on-entry (which can be seen from the output of the liveness analysis in step 203), and where all exit-nodes in the component are branch-to-link register.

The rules used to identify fundamental patterns in the software system can vary depending on the source code used to generate the assembly or object code. Thus, specific rules can identify functions for C-type procedural programming languages, while other rules, or variations of these rules, can be used to identify functions for other types of procedural programming languages.

In step 207, high-level patterns are determined from the control-flow graph using a second set of defined rules. The second set of defined rules use the results of steps 201, 203 and 205 and characteristics of the control-flow graph to determine the high-level patterns. For example, a register which is live-on-entry to a function found during step 205 may be assumed to be a function parameter. Consequently, all references to that register within the function can then be replaced by a symbolic reference to a parameter.

The parameter can be given an arbitrary name (for example “parameter1”), as it is easier for a programmer to relate to a name rather than a memory address or register. Of course, in the source language, “parameter1” may actually have been called something more descriptive (for example “count_value”), but this information will have been lost with the debug information database.

The procedure in step 207 operates in an iterative manner, which means that patterns identified in the control-flow graph can be used to identify further patterns in the control-flow graph. Step 207 can be performed until all patterns in the CFG have been identified.

In step 209, once all patterns have been found, a debug information database can be generated using the information determined in steps 203, 205 and 207. In addition, the Information in the debug information database can be augmented by further information, such as symbol tables (which are often retained, even if the symbolic data has been lost). For example, if a symbol table contains the information that a particular program location has a name, and that program location is known to be a function, then It is reasonable to assume that the function has that name, and the database can be updated accordingly.

In step 211, the debug information database is translated into a form that can be used by a debugger.

A specific example will now be presented that illustrates the procedure according to the invention.

Consider the following fragment of assembly code.

| | |
|---|---|
| “max: | |
| cmp r0,r1 | // Compare r0 against r1 and set the condition flags |
| | // appropriately |
| bge ret | // If r0 > r1 branch to ‘ret’ label |
| copy r1,r0 | // r0 <= r1, so perform the assignment r0 := r1 |
| ret: | |
| jr (lr) | // Branch to the destination given in register lr (the |
| | // link register)” |

Referring to FIG. 2, the algorithm according to the invention can be used to generate debug information for this simple example as follows. According to step 201, a control-flow graph for the code is generated. This is shown in FIG. 3. In FIG. 3, each box represents a ‘basic block’, which is a simple sequence of instructions. Edges in the graph denote control-flow transfer.

In step 203, the control-flow graph is analysed to determine basic information such as reaching definitions, exposed uses, and live ranges (i.e. where a register holds a useful value).

For example, analysis of the code would determine that register Ir is used at the end of the fragment, and is not written within the fragment. Thus, register Ir is always live (i.e. always holds a useful value). The value that the register held on entry to the fragment is used at the exit of the fragment.

The analysis would also show that registers r0 and r1 are used within the function, with no definition prior to their first use. Thus, like the Ir register, they are live-on-entry.

The analysis would finally show that register r0 is written to by the copy instruction, but never used subsequently. Alternatively, in the other possible execution path, r0 has the value the caller gave it. Thus, the value will be live-on-exit (i.e. the value written by the copy instruction will be available to the code that is executing at the destination given by the Ir register).

In step 205, the control-flow graph and the liveness information generated in steps 201 and 203 respectively are queried using a set of predefined rules, which look for known source constructs.

For example, a function is found by applying the following queries:

(i) A function must be a ‘component’ of the graph, where a component is a set of nodes for which there is a path from one node to another. Informally, during the drawing of a graph, a component of the graph is a set of nodes that can be ringed around, without crossing an edge.
(ii) Functions should have a single entry node (it will be appreciated by a person skilled in the art that there can be exceptions to this). In the example, the node at the top of the CFG has no edges pointing into it, and is therefore an entry node. It is the only such entry node in the graph, so is the function entry point (the point to which control is transferred when the function is called).
(iii) The link-register (Ir) must be live-on-entry. That is, when control is transferred to the possible function, the link register will be set to the return point of the function. The code only represents a function if the link register is unmodified between the entry point of the possible function, and all exit points (i.e. control will return to the point specified by the caller).
(iv) All exit nodes in the CFG (i.e. nodes from which control passes out of the CFG) must return to the link-register. Returning to a different execution position would result in a function call failing to return to its caller, and consequently it would not be a real function.

All of these rules, when queried using the databases generated in steps 201 and 203, are determined to be true, so the code fragment represents a function.

In step 207, the information from steps 201 and 203 is combined with the fundamental patterns discovered in step 205. For example, the liveness information indicates that registers r0 and r1 are live-on-entry to the CFG, and the CFG is now known to be a function. Therefore, it can be inferred that r0 and r1 are parameters to the function. Since r0 and r1 are register values, the parameters can be assigned a type equivalent to a 16-bit signed quantity (for example an ISO C type ‘int16_t’). For convenience, the parameters can be given symbolic names to indicate their purpose: param0 and param1 for example.

In addition, as the register r0 is known to be live-on-exit from a CFG known to be a function, the value contained in r0 will be available to the caller, and is a ‘return value’ of the function. It is a register value, so is equivalent to an ‘int16_t’ type.

Thus, the function in the above example has been determined to have a form equivalent to the C prototype:
int function (int param0, int param1)

In step 209, debug information is generated from the output of steps 201-207. For example, a function record is created, spanning the instructions from the original program fragment. The function has two parameters with types ‘int16_t’ and names param0 and param1. The live ranges of the parameters are set up appropriately, to record when the parameters contain valid values.

A symbol table records information that the newly discovered function's entry node has been given the name ‘max’. Hence, the function prototype generated in step 207 is assigned the name ‘max’:
int max (int param0, int param1).

In step 213, the database is generated in an appropriate format, such as DWARF.

From the above example, it will be appreciated that the invention is applicable both to a complete program or system represented in an assembly language, or just a part or fragment of the program or system.

There is therefore provided a method that allows high-level symbolic debug information, and in particular construct information, to be generated from low-level object or assembly code.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope. A computer program may be stored/distributed on a suitable medium, such as an optical storage medium or a solid-state medium supplied together with or as part of other hardware, but may also be distributed in other forms, such as via the Internet or other wired or wireless telecommunication systems.

1. A method of generating information for a software system for use in a debug information database, the software system being defined in a low-level program code, the method comprising:
constructing a representation of the software system from the low-level program code;
examining the representation to identify predetermined patterns; and
generating a database of debug information for the software system from the results of the step of examining.

2. A method as claimed in claim 1, wherein the step of examining the representation to identify predetermined patterns comprises analysing the representation using techniques to produce an intermediate data structure.

3. A method as claimed in claim 2, wherein the techniques include liveness analysis generated from a reaching definitions analysis or exposed use analysis.

4. A method as claimed in claim 1, wherein the step of examining comprises examining the representation using a defined set of rules.

5. A method as claimed in claim 4, wherein the rules comprise queries for identifying functions and/or loops in the representation.

6. A method as claimed in claim 4, wherein the step of examining further comprises examining the representation to identify high-level patterns.

7. A method as claimed in claim 6, wherein the high-level patterns include function parameters.

8. A method as claimed in claim 1, wherein the step of constructing a representation of the software system comprises constructing a control-flow graph representation of the software system.

9. A method as claimed in claim 1, further comprising the step of transforming the information in the database into a form that is suitable for use by a debugger.

10. A computer program comprising code that performs the method of claim 1 when executed in a computer.

11. A computer program product comprising a computer program as claimed in claim 10 embodied therein.
